(19) United States
(12) Patent Application Publication
(10) Pub. No.: US 2022/0188993 A1
(43) Pub. Date: Jun. 16, 2022

(54) CONTROL APPARATUS, PHOTOGRAPHING APPARATUS, CONTROL METHOD, AND PROGRAM

(71) Applicant: SZ DJI TECHNOLOGY CO., LTD., Shenzhen (CN)

(72) Inventors: Kenichi HONJO, Shenzhen (CN); Yoshinori NAGAYAMA, Shenzhen (CN)

(73) Assignee: SZ DJI TECHNOLOGY CO., LTD., Shenzhen (CN)

(21) Appl. No.: 17/683,163

(22) Filed: Feb. 28, 2022

Related U.S. Application Data
(63) Continuation of application No. PCT/CN2020/113963, filed on Sep. 8, 2020.

(30) Foreign Application Priority Data
Sep. 20, 2019 (JP) 2019-171306

(51) Int. Cl. G06T 5/00; H04N 5/232; G06T 7/521; G06T 7/70; G01S 17/86; G01S 17/10; G01S 7/51

(52) U.S. Cl. CPC G06T 5/006; H04N 5/23293; G06T 7/521; H04N 5/23212; G06T 2207/10028; G01S 17/86; G01S 17/10; G01S 7/51; G06T 7/70

(57) ABSTRACT

A control apparatus controls a photographing apparatus that includes a ranging sensor that measures a distance to a photographed object associated with each of a plurality of distance measurement areas on a light-receiving surface of a light-receiving element and an image sensor that captures an image of the photographed object. The control apparatus includes a circuit configured to: correct a predetermined positional relationship between the plurality of distance measurement areas on the light-receiving surface of the light-receiving element and a plurality of photographing areas on a light-receiving surface of the image sensor based on a plurality of distances measured by the ranging sensor; determine, based on the corrected positional relationship, a first distance measurement area corresponding to a first photographing area of a focused object; and perform focus control of the photographing apparatus based on a distance of the first distance measurement area measured by the ranging sensor.

### RELATED APPLICATIONS

This application is a continuation application of PCT application No. PCT/CN2020/113963, filed on Sep. 8, 2020, which claims the priority of Japanese patent application No. JP 2019-171306, filed on Sep. 20, 2019, and the contents of which are incorporated herein by reference in the entirety.

### TECHNICAL FIELD

The present disclosure relates to a control apparatus, a photographing apparatus, a control method, and a program.

### BACKGROUND

A distance value may be calculated based on a TOF (Time of Flight) algorithm of each of M×N pixels, and then that distance information may be stored in a depth map memory.

### BRIEF SUMMARY

A positional relationship between a light-receiving surface of a TOF sensor and a light-receiving surface of an image sensor of a photographing apparatus varies with a distance to a photographed object measured by the TOF sensor. Sometimes, due to an error in a positional relationship between a position of the photographed object on the light-receiving surface of the TOF sensor and a position of the photographed object on the light-receiving surface of the image sensor of the photographing apparatus, it is impossible to focus on the desired photographed object.

According to one aspect of the present disclosure, a control apparatus for controlling a photographing apparatus is provided, including: at least one storage medium storing a set of instructions for controlling the photographing apparatus, wherein the photographing apparatus includes: a TOF(Time of Flight) sensor that measures distances of a plurality of objects, each of the plurality of objects being corresponding to a distance measurement area on a light receiving surface of a light receiving element, and an image sensor that captures an image of the plurality of photographed objects; and at least one processor in communication with the at least one storage medium, wherein during operation, the at least one processor executes the set of instructions to: determine, based on a plurality of distances measured by the TOF sensor, a plurality of adjacent distance measurement areas within a predetermined distance range as a group area, and display a box including the group area on a display portion as the box indicating an existing position of the photographed object.

According to another aspect of the present disclosure, a photographing apparatus is provided, including: a photographing apparatus is provided, including: a TOF(Time of Flight) sensor that measures distances of a plurality of objects, each of the plurality of objects being corresponding to a distance measurement area on a light receiving surface of a light receiving element; an image sensor that captures an image of the plurality of photographed objects; and a control apparatus, including: at least one storage medium storing a set of instructions for controlling the photographing apparatus, and at least one processor in communication with the at least one storage medium, wherein during operation, the at least one processor executes the set of instructions to: determine, based on a plurality of distances measured by the TOF sensor, a plurality of adjacent distance measurement areas within a predetermined distance range as a group area, and display a box including the group area on a display portion as the box indicating an existing position of the photographed object.

According to yet another aspect of the present disclosure, a control method for controlling a photographing apparatus is provided, including: providing a photographing apparatus including: a TOF(Time of Flight) sensor that measures distances of a plurality of objects, each of the plurality of objects being corresponding to a distance measurement area on a light receiving surface of a light receiving element, an image sensor that captures an image of the plurality of photographed objects, and a control apparatus; determining, based on a plurality of distances measured by the TOF sensor, a plurality of adjacent distance measurement areas within a predetermined distance range as a group area; and displaying a box including the group area on a display portion as the box indicating an existing position of the photographed object.

One aspect of the present disclosure can avoid an impossibility of focusing on the desired photographed object due to an impact of an error in the positional relationship between the position of the photographed object on the light-receiving surface of the light-receiving element of the TOF sensor and the position of the photographed object on the light-receiving surface of the image sensor of the photographing apparatus.

The summary above does not list all I features of the present disclosure. In addition, sub-combinations of these feature groups may also fall within the scope of the present disclosure.

### BRIEF DESCRIPTION OF THE DRAWINGS

FIG. 1 is an exterior perspective view of a photographing system;

FIG. 2 is a diagram showing functional blocks of a photographing system;

FIG. 3 is a diagram showing an example of a positional relationship between an optical axis of a lens of a photographing apparatus and an optical axis of a lens of a TOF sensor;

FIG. 4 is a diagram showing an example of a positional relationship between a plurality of photographing areas of an image sensor and a plurality of distance measurement areas of a TOF sensor;

FIG. 5 is a diagram showing an example of a positional relationship between a plurality of photographing areas of an image sensor and a plurality of distance measurement areas of a TOF sensor;

FIG. 6 is a diagram showing an example of a table presenting a correspondence between a coordinate system associated with a light-receiving surface of a TOF sensor and a coordinate system associated with a light-receiving surface of an image sensor;

FIG. 7 is a diagram showing an example of a correction condition indicating a relationship between a distance to a photographed object and a correction amount;

FIG. 8 is a diagram showing an example of a table presenting a corrected correspondence between a coordinate system associated with a light-receiving surface of a TOF sensor and a coordinate system associated with a light-receiving surface of an image sensor;

FIG. 9 is a flowchart showing an example of a focus control process of a photographing control portion;

FIG. 10 is a flowchart showing an example of a focus control process of a photographing control portion;

FIG. 11 is an exterior perspective view showing a photographing system;

FIG. 12 is a diagram showing an example of exteriors of an unmanned aerial vehicle and a remote operation apparatus; and

FIG. 13 is a diagram showing an example of a hardware configuration.

### DESCRIPTION OF REFERENCE NUMERALS

10: photographing system

20: UAV body

50: universal joint

60: photographing apparatus

100: photographing apparatus

110: photographing control portion

120: image sensor

130: memory

150: lens control portion

152: lens driving portion

154: lens

160: TOF sensor

162: light-emitting portion

163: light-emitting element

164: light-receiving portion

165: light-receiving element

166: light-emitting control portion

167: light-receiving control portion

168: memory

200: supporting mechanism

201: roll axis driving mechanism

202: pitch axis driving mechanism

203: yaw axis driving mechanism

204: base

210: posture control portion

212: angular velocity sensor

214: acceleration sensor

300: holding portion

301: operation interface

302: display portion

400: smartphone

600: remote operation apparatus

1200: computer

1210: host controller

1212: CPU

1214: RAM

1220: input/output controller

1222: communications interface

1230: ROM

### DETAILED DESCRIPTION

The following describes the present disclosure with some exemplary embodiments. However, the following exemplary embodiments do not limit the disclosure. In addition, all feature combinations described herein are not necessary for solutions of the present disclosure. For a person of ordinary skill in the art, variations or improvements may be made to the exemplary embodiments. Obviously, these variations or improvements are included in the scope of the present disclosure.

The claims, the specification, the accompanying drawings, and the abstract may contain materials which are subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Each embodiment of the present disclosure may be described with reference to the flowchart and block diagram. Herein the block may indicate (1) a stage of a process of performing an operation or (2) a “portion” of an apparatus having a function of performing an operation. A specific stage and “portion” may be implemented by a programmable circuit and/or a processor. A dedicated circuit may include a digital and/or analog hardware circuit, and may include an integrated circuit (IC) and/or a discrete circuit. The programmable circuit may include a reconfigurable hardware circuit. The reconfigurable hardware circuit may include logic AND, logic OR, logic XOR, logic NAND, logic NOR, and other logic operations, and storage elements such as a trigger, a register, a field programmable gate array (FPGA), and a programmable logic array (PLA).

A computer-readable medium may include any tangible device that may store an instruction executed by an appropriate device. As a result, the computer-readable medium storing an instruction(s) may include a product including an instruction, where the instruction may be executed to perform an operation specified by the flowchart or block diagram. An example of the computer-readable medium may include an electronic storage medium, a magnetic storage medium, an optical storage medium, an electromagnetic storage medium, a semiconductor storage medium, or the like. A more specific example of the computer-readable medium may include a floppy disk (registered trademark), a floppy magnetic disk, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disc (DVD), a Blu-ray (registered trademark) disc, a memory stick, an integrated circuit card, or the like.

A computer-readable instruction may include any one of source code or target code described by any combination of one or more programming languages. The source code or the target code may include a conventional program-mode programming language. The conventional program type programming language may be an object-oriented programming language and a “C” programming language or a similar programming language, for example, an assembly instruction, an instruction set architecture (ISA) instruction, a machine instruction, a machine-related instruction, micro code, a firmware instruction, status setting data, or Smalltalk (registered trademark), JAVA (registered trademark), or C++. The computer-readable instruction may be provided locally or provided through a local area network (LAN) or a wide area network (WAN) such as the Internet to a processor or programmable circuit of a general-purpose computer, a dedicated computer, or another programmable data processing apparatus. The processor or programmable circuit may execute the computer-readable instruction to create a means for performing an operation specified by the flowchart or block diagram. An example of the processor includes a computer processor, a processing unit, a microprocessor, a digital signal processor, a controller, a microcontroller, or the like.

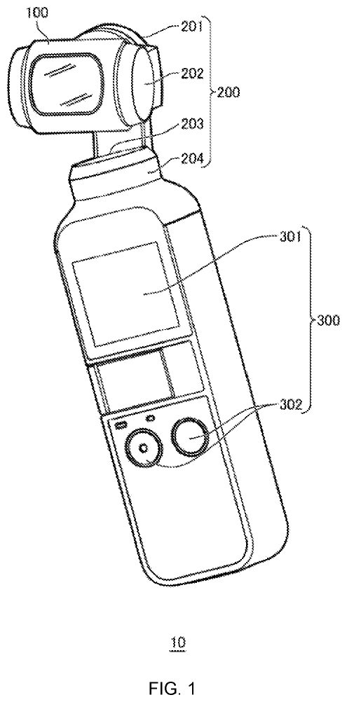

FIG. 1 is an example of an exterior perspective view of a photographing system 10. The photographing system 10 may include a photographing apparatus 100, a supporting mechanism 200, and a holding portion 300. The supporting mechanism 200 may use an actuator to rotatably support the photographing apparatus 100 around a roll axis, a pitch axis, and a yaw axis respectively. The supporting mechanism 200 may change or maintain a posture of the photographing apparatus 100 by rotating the photographing apparatus 100 around at least one of the roll axis, the pitch axis, or the yaw axis. The supporting mechanism 200 may include a roll axis driving mechanism 201, a pitch axis driving mechanism 202, and a yaw axis driving mechanism 203. The supporting mechanism 200 may further include a base 204 to which the yaw axis driving mechanism 203 is fixed. The holding portion 300 is fixed to the base 204. The holding portion 300 may include an operation interface 301 and a display portion 302. The photographing apparatus 100 may be fixed to the pitch axis driving mechanism 202.

The operation interface 301 may receive a user's instruction(s) to operate the photographing apparatus 100 and the supporting mechanism 200. The operation interface 301 may include a shutter/recording button for instructing the photographing apparatus 100 to perform photographing or recording. The operation interface 301 may include a power/function button for instructing to power on or off the photographing system 10 and switch a still image shooting mode or a moving picture shooting mode of the photographing apparatus 100.

The display portion 302 may display an image captured by the photographing apparatus 100. The display portion 302 may display a menu screen for operating the photographing apparatus 100 and the supporting mechanism 200. The display portion 302 may be a touchscreen display that receives the instructions to operate the photographing apparatus 100 and the supporting mechanism 200.

The user holds the holding portion 300, and shoots still images or moving pictures by using the photographing apparatus 100.

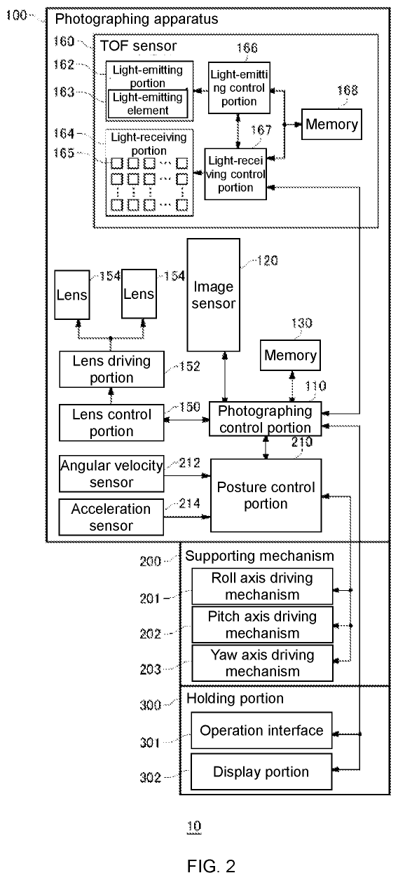

FIG. 2 is a diagram showing functional blocks of the photographing system 10. The photographing apparatus 100 may include a photographing control portion 110, an image sensor 120, a memory 130, a lens control portion 150, a lens driving portion 152, a plurality of lenses 154, and a TOF sensor 160.

The image sensor 120 may include a CCD or a CMOS. The image sensor 120 is an example of an image sensor used for photographing. The image sensor 120 outputs image data of optical images formed by the plurality of lenses 154 to the photographing control portion 110. The photographing control portion 110 may include a microprocessor such as a CPU or an MPU, and a microcontroller such as an MCU.

The photographing control portion 110 follows an instruction of the holding portion 300 for the photographing apparatus 100, and the photographing control portion 110 performs demosaic processing on an image signal output from the image sensor 120 to generate image data. The photographing control portion 110 stores image data in the memory 130. The photographing control portion 110 controls the TOF sensor 160. The photographing control portion 110 is an example of a circuit. The TOF sensor 160 is a time-of-flight sensor that measures a distance to an object. The photographing apparatus 100 adjusts a position of a focus lens based on the distance measured by the TOF sensor 160, thereby performing focus control. The photographing control portion 110 may be a hardware circuit unit or may be one or more processors, such as one or more CPU, GPU, that are in communication with the memory 130. During operation, the photographing control portion 110 may execute instructions stored in the memory 130 to perform photographing control.

The memory 130 may be a computer-readable storage medium, and may include at least one of a SRAM, a DRAM, an EPROM, an EEPROM, and a flash memory such as a USB memory. The memory 130 may store a program required for the photographing control portion 110 to control the image sensor 120 and the like. The memory 130 may be disposed in a housing of the photographing apparatus 100. The holding portion 300 may include another memory for storing image data captured by the photographing apparatus 100. The holding portion 300 may include a slot through which the memory can be detached from the housing of the holding portion 300.

The plurality of lenses 154 may function as zoom lenses, varifocal lenses, and focus lenses. At least some or all of the plurality of lenses 154 may be configured to move along an optical axis. The lens control portion 150 drives the lens driving portion 152 according to a lens control instruction from the photographing control portion 110 to move one or more lenses 154 along a direction of the optical axis. The lens control portion 150 may be a hardware circuit unit, or may be the one or more processors. During operation, the lens control portion 150 may execute instructions stored in the memory 130 to perform lens control. The lens control instruction may be, for example, a zoom control instruction and a focus control instruction. The lens driving portion 152 may include a voice coil motor (VCM) that moves at least some or all of the plurality of lenses 154 along the direction of the optical axis. The lens driving portion 152 may include a motor such as a DC motor, a coreless motor, or an ultrasonic motor. The lens driving portion 152 may transfer power from the motor to at least some or all of the plurality of lenses 154 by using mechanical members such as cam rings and guide shafts, and move at least some or all of the plurality of lenses 154 along the optical axis. In some exemplary embodiments, the plurality of lenses 154 is integrated with the photographing apparatus 100. However, the plurality of lenses 154 may be interchangeable lenses, and may be configured separately from the photographing apparatus 100.

The photographing apparatus 100 may further include a posture control portion 210, an angular velocity sensor 212, and an acceleration sensor 214. The angular velocity sensor 212 detects an angular velocity of the photographing apparatus 100. The angular velocity sensor 212 detects angular velocities of the photographing apparatus 100 around the roll axis, the pitch axis, and the yaw axis. The posture control portion may be a hardware circuit unit or the one or more processors. During operation, the posture control portion 210 may execute instructions stored in the memory 130 to conduct posture control. The posture control portion 210 obtains angular velocity information related to the angular velocities of the photographing apparatus 100 from the angular velocity sensor 212. The angular velocity information may show the angular velocities of the photographing apparatus 100 around the roll axis, the pitch axis, and the yaw axis. The posture control portion 210 obtains acceleration information related to an acceleration of the photographing apparatus 100 from the acceleration sensor 214. The acceleration information may also show an acceleration of the photographing apparatus 100 in each direction of the roll axis, the pitch axis, and the yaw axis.

The angular velocity sensor 212 and the acceleration sensor 214 may be disposed in a housing that accommodates the image sensor 120, the lens 154, and the like. In some exemplary embodiments, it may be an integrated form of the photographing apparatus 100 and the supporting mechanism 200. However, the supporting mechanism 200 may include a base for detachably fixing the photographing apparatus 100. In this case, the angular velocity sensor 212 and the acceleration sensor 214 may be disposed outside the housing of the photographing apparatus 100, for example, on the base.

The posture control portion 210 controls the supporting mechanism 200 based on the angular velocity information and acceleration information to maintain or change the posture of the photographing apparatus 100. The posture control portion 210 controls the supporting mechanism 200 based on an operating mode of the supporting mechanism 200 for controlling the posture of the photographing apparatus 100, to maintain or change the posture of the photographing apparatus 100.

The operating mode may include the following mode: operating at least one of the roll axis driving mechanism 201, the pitch axis driving mechanism 202, and the yaw axis driving mechanism 203 of the supporting mechanism 200, so that the posture change of the photographing apparatus 100 follows a posture change of the base 204 of the supporting mechanism 200. Alternatively, the working mode may be as follows: operating each of the roll axis driving mechanism 201, the pitch axis driving mechanism 202, and the yaw axis driving mechanism 203 of the supporting mechanism 200, so that the posture change of the photographing apparatus 100 follows a posture change of the base 204 of the supporting mechanism 200. Alternatively, the working mode may be as follows: operating each of the pitch axis driving mechanism 202 and the yaw axis driving mechanism 203 of the supporting mechanism 200, so that the posture change of the photographing apparatus 100 follows a posture change of the base 204 of the supporting mechanism 200. Alternatively, the working mode may be as follows: operating only the yaw axis driving mechanism 203, so that the posture change of the photographing apparatus 100 follows a posture change of the base 204 of the supporting mechanism 200.

The operating mode may include the following mode: an FPV (first person view) mode for operating the supporting mechanism 200, so that the posture change of the photographing apparatus 100 follows a posture change of the base 204 of the supporting mechanism 200; and a fixed mode for operating the supporting mechanism 200 to maintain the posture of the photographing apparatus 100.

The FPV mode is a mode for operating at least one of the roll axis driving mechanism 201, the pitch axis driving mechanism 202, and the yaw axis driving mechanism 203, so that the posture change of the photographing apparatus 100 may follow a posture change of the base 204 of the supporting mechanism 200. The fixed mode is a mode for operating at least one of the roll axis driving mechanism 201, the pitch axis driving mechanism 202, and the yaw axis driving mechanism 203, to maintain the current posture of the photographing apparatus 100.

The TOF sensor 160 may include a light-emitting portion 162, a light-receiving portion 164, a light-emitting control portion 166, a light-receiving control portion 167, and a memory 168. The TOF sensor 160 is an example of a ranging sensor.

The light-emitting portion 162 may include at least one light-emitting element 163. The light-emitting element 163 is a device that repeatedly emits high-speed modulated pulsed light such as an LED or a laser. The light-emitting element 163 may emit infrared pulsed light. The light-emitting control portion 166 controls the light-emitting element 163 to emit light. The light-emitting control portion 166 may control a pulse width of the pulsed light emitted from the light-emitting element 163.

The light-receiving portion 164 may include a plurality of light-receiving elements 165, each of which measures a distance to a photographed object associated with one of a plurality of distance measurement areas. The light-receiving portion 164 is an example of a ranging sensor. The plurality of light-receiving elements 165 respectively correspond to the plurality of distance measurement areas. The light-receiving element 165 repeatedly receives, from the object, reflected light of the pulsed light. The light-receiving control portion 167 controls the light-receiving element 165 to receive light. The light-receiving control portion 167 measures, based on an amount of reflected light repeatedly received by the light-receiving element 165 in a predetermined light-receiving period, the respective distances to the photographed objects associated with the plurality of distance measurement areas. The light-receiving control portion 167 may measure the distance to one photographed object by determining a phase difference between the pulsed light and the reflected light based on the amount of reflected light repeatedly received by the light-receiving element 165 in the predetermined light-receiving period. The light-receiving portion 164 may measure the distance to the photographed object by reading a frequency change of a reflected wave. This is referred to as an FMCW (frequency modulated continuous wave) mode.

The light-emitting control portion 166 may be a hardware circuit unit or the one or more processors. The light-receiving control portion 167 may be a hardware circuit unit or the one or more processors. The memory 168 may be a computer-readable recording medium, and may include at least one of an SRAM, a DRAM, an EPROM, and an EEPROM. The memory 168 may store a program required for the light-emitting control portion 166 to control the light-emitting portion 162, a program required for the light-receiving control portion 167 to control the light-receiving portion 164, and the like.

The TOF sensor 160 may measure the distances to the photographed objects associated with each of the plurality of distance measurement areas corresponding to a quantity of pixels of the light-receiving portion 164. However, generally, the quantity of pixels of the light-receiving portion 164 is less than a quantity of pixels of the image sensor 120 for photographing of the photographing apparatus 100. In addition, a positional relationship between a light-receiving surface of the light-receiving portion 164 of the TOF sensor 160 and a light-receiving surface of the image sensor 120 of the photographing apparatus 100 may vary with the distance to the photographed object measured by the TOF sensor 160. Therefore, even if the photographed object is detected based on distance information from the TOF sensor 160, and the photographing apparatus 100 performs focus control based on the distance to the photographed object measured by the TOF sensor 160, sometimes it is impossible to focus on the photographed object desired by the user.

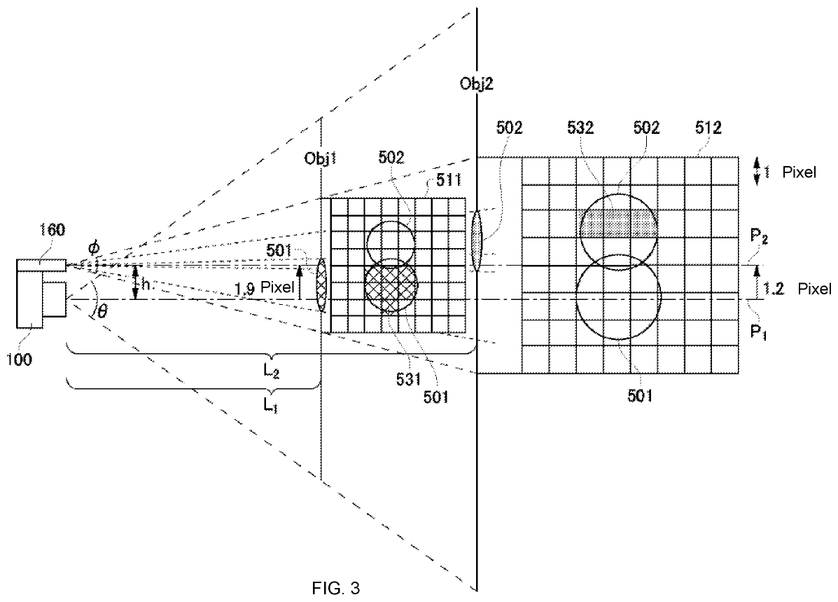

FIG. 3 shows a positional relationship between a position of the photographed object on the light-receiving surface of the light-receiving portion 164 of the TOF sensor 160 and a position of the photographed object on the light-receiving surface of the image sensor 120 of the photographing apparatus 100. FIG. 3 shows a case in which the photographing apparatus 100 is photographing a photographed object (Obj1) 501 at a distance L1 from the photographing apparatus 100 and a photographed object (Obj2) 502 at a distance L2 from the photographing apparatus 100.

An angle of view of the photographing apparatus 100 is θ, and an angle of view of the TOF sensor 160 is φ. A distance between an optical axis P1 of the photographing apparatus 100 and an optical axis P2 of the TOF sensor 160 is h. The distance measurement areas of the TOF sensor 160 are 8 pixels *8 pixels, that is, 64 areas. In this case, one distance measurement area is equivalent to one pixel of the light-receiving portion 164.

An area 511 indicates the positional relationship between the distance measurement areas and the photographing areas of the photographing apparatus 100 when the distance from the photographing apparatus 100 is L1. An area 512 indicates the positional relationship between the distance measurement areas and the photographing areas of the photographing apparatus 100 when the distance from the photographing apparatus 100 is L2.

The distance between the optical axis P1 of the image sensor 120 and the optical axis P2 of the TOF sensor 160 is h. The optical axis P2 of the TOF sensor 160 passes through a center of the plurality of distance measurement areas of the TOF sensor 160. However, in the distance L1, the optical axis P1 of the photographing apparatus 100 is 1.9 pixels away from the center of the plurality of distance measurement areas of the TOF sensor 160. On the other hand, in the distance L2, the optical axis P1 of the photographing apparatus 100 is 1.2 pixels away from the center of the plurality of distance measurement areas of the TOF sensor 160. In other words, according to the distance between the photographing apparatus 100 and the photographed object, the distance between the optical axis P1 of the photographing apparatus 100 and the center of the plurality of distance measurement areas of the TOF sensor 160 may be different. This phenomenon is referred to as a parallax.

The photographing apparatus 100 in some exemplary embodiments may correct the positional relationship between the light-receiving surface of the image sensor 120 and the light-receiving surface of the light-receiving portion 164 of the TOF sensor 160 based on the distance to the photographed object measured by the TOF sensor. Further, the photographing apparatus 100 may determine, based on the corrected positional relationship, a distance measurement area of the TOF sensor 160 corresponding to the position of the photographed object on the image captured by the photographing apparatus 100, and perform focus control based on a distance of the determined measurement area measured by the TOF sensor 160.

The photographing control portion 110 obtains the distance to the photographed object associated with each of the plurality of distance measurement areas measured by the TOF sensor 160. The photographing control portion 110 corrects the predetermined positional relationship between the plurality of distance measurement regions on the light-receiving surface of the light-receiving portion 164 and the plurality of photographing areas on the light-receiving surface of the image sensor 120 based on a plurality of distances.

The photographing control portion 110 may determine, based on a predetermined correction condition indicating a correction amount of a positional relationship corresponding to the angle of view of the TOF sensor 160, the angle of view of the photographing apparatus 100, and the distance to the photographed object, correction amounts corresponding to the plurality of distances measured by the TOF sensor 160, and correct the positional relationship based on the determined correction amounts. The photographing control portion 110 may correct the positional relationship by moving the position on the light-receiving surface of the TOF sensor 160 corresponding to the position on the light-receiving surface of the image sensor 120 by a quantity of pixels corresponding to the correction amount.

The predetermined positional relationship may be determined based on a positional relationship between a position of an optical axis center on the light-receiving surface of the light-receiving portion 164 and a position of an optical axis center on the light-receiving surface of the image sensor 120. The predetermined positional relationship may indicate a correspondence between a first coordinate system associated with the light-receiving surface of the light-receiving portion 164 and a second coordinate system associated with the light-receiving surface of the image sensor 120.

The photographing control portion 110 may determine a first distance measurement area corresponding to a first photographing area of a focused object among the plurality of distance measurement areas based on the corrected positional relationship. The photographing control portion 110 may perform focus control of the photographing apparatus 100 based on the distance of the first distance measurement area measured by the TOF sensor 160. The focus control is a control of moving the focus lens to focus on the photographed object existing in the distance of the first distance measurement area. The photographing control portion 110 may classify the plurality of distance measurement areas into group areas based on the plurality of distances measured by the TOF sensor 160 and adjacent distance measurement areas within a predetermined distance range. An area surrounded by an adjacent distance measurement area within the predetermined distance range is an area in which the photographed object is likely to exist within the distance range. Assuming that a reference distance is L, the predetermined distance range may be L±αL (0<α<1). For example, when L is 1 m, assuming α=0.1, the predetermined distance range may be 0.9 m to 1.1 m. The photographing control portion 110 may classify the plurality of distance measurement areas into group areas based on the plurality of distances measured by the TOF sensor 160 and adjacent distance measurement areas within the same distance range. The photographing control portion 110 may correct the positional relationship for each group area.

The photographing control portion 110 may determine, based on the corrected positional relationship, a group area corresponding to the first photographing area. The photographing control portion 110 may perform focus control of the photographing apparatus 100 based on a distance of the group area, where the distance of the group area is based on the plurality of distances measured by the TOF sensor 160. The photographing control portion 110 may perform focus control of the photographing apparatus 100 based on a distance of a distance measurement area located in a reference position of the group area among a plurality of distance measurement areas included in the group area. The reference position may be, for example, a half of a maximum length in a column direction and a maximum length in a row direction of the group area. Even if the reference position is not a half, the row direction and column direction can be weighted separately to set the reference position. The photographing control portion 110 may perform focus control of the photographing apparatus 100 based on an average value of distances of the plurality of distance measurement areas included in the group area.

Alternatively, after correcting the positional relationship based on distances of the plurality of distance measurement areas, the photographing control portion 110 may classify the plurality of distance measurement areas in the corrected positional relationship into group areas based on adjacent distance measurement areas within a predetermined distance range. Alternatively, after correcting the positional relationship based on distances of the plurality of distance measurement areas, the photographing control portion 110 may classify the plurality of distance measurement areas in the corrected positional relationship into group areas based on adjacent distance measurement areas within the same distance range. The photographing control portion 110 may determine, based on the positional relationship after the plurality of distance measurement areas are classified into the group areas, the group area corresponding to the first photographing area, and perform focus control of the photographing apparatus 100 based on the distance of the group area, where the distance of the group area is based on the plurality of distances measured by the TOF sensor 160.

The photographing control portion 110 may superimpose a box indicating the position of the photographed object, on a position of the captured image captured by the photographing apparatus 100 and corresponding to the group area, and display the box on the display portion 302, or the like.

For example, the photographing apparatus 100 may determine a plurality of adjacent distance measurement areas within a predetermined distance range measured by the TOF sensor 160, superimpose a box(es) containing the determined plurality of distance measurement areas, on the captured image as a box indicating the existing position of the photographed object, and display the box(es) on the display portion 302 or the like as a preview image.

In FIG. 3, the photographing control portion 110 may classify adjacent seven pixels included in a distance range indicating the distance L1, as a group area 531 corresponding to the photographed object 501. The photographing control portion 110 may classify adjacent three pixels included in a distance range indicating the distance L2, as a group area 532 corresponding to the photographed object 502. The memory 130 may store a correction amount of a positional relationship corresponding to the angle of view (φ) of the TOF sensor 160, the angle of view (θ) of the photographing apparatus 100, and the distance L1 as 1.9 pixels. In addition, the memory 130 may store a correction amount of a positional relationship corresponding to the angle of view (φ) of the TOF sensor 160, the angle of view (θ) of the photographing apparatus 100, and the distance L2 as 1.2 pixels. The photographing control portion 110 may correct the positional relationship by moving a position of a photographing area corresponding to the group area 531 upward by an amount equivalent to 1.9 pixels. The photographing control portion 110 may correct the positional relationship by moving a position of a photographing area corresponding to the group area 532 upward by an amount equivalent to 1.2 pixels.

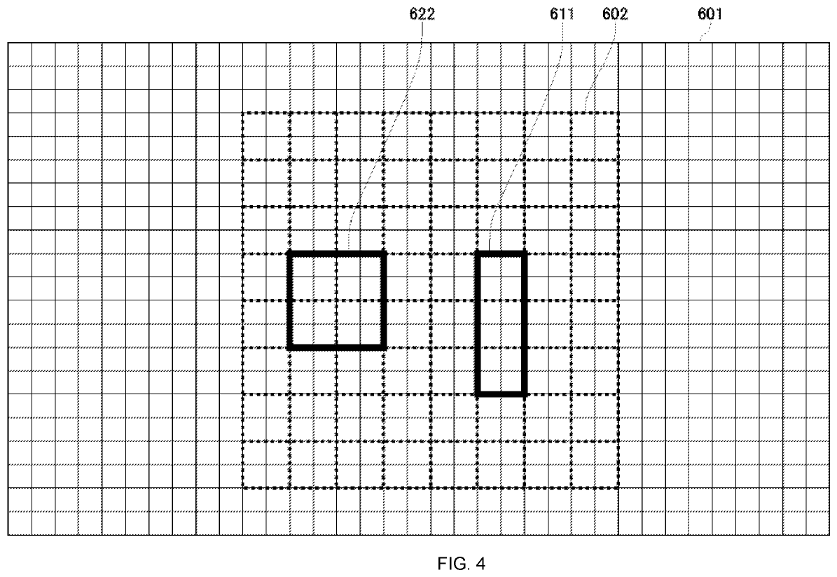

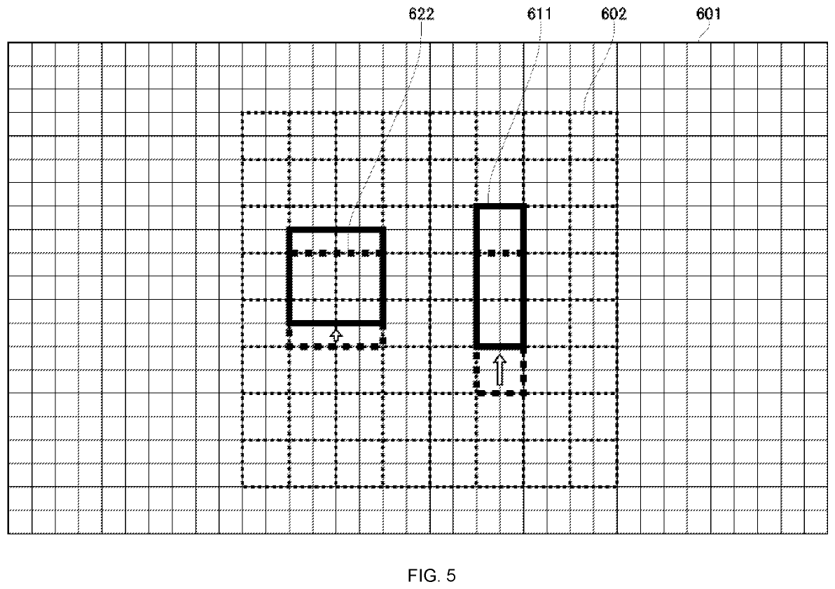

FIG. 4 and FIG. 5 are diagrams showing an example of a positional relationship between a plurality of photographing areas 601 of the image sensor 120 and a plurality of distance measurement areas 602 of the TOF sensor 160. As shown in FIG. 4, the photographing control portion 110 determines, from the plurality of distance measurement areas 602, a group area 611 and a group area 622 including a plurality of adjacent distance measurement areas within a same distance range. The photographing control portion 110 determines, based on predetermined correction conditions stored in the memory 130, correction amounts corresponding to distances of the group area 611 and the group area 622. As shown in FIG. 5, the photographing control portion 110 corrects the positional relationship by moving the positions of the photographing areas corresponding to the group area 611 and the group area 622 by the determined correction amounts respectively.

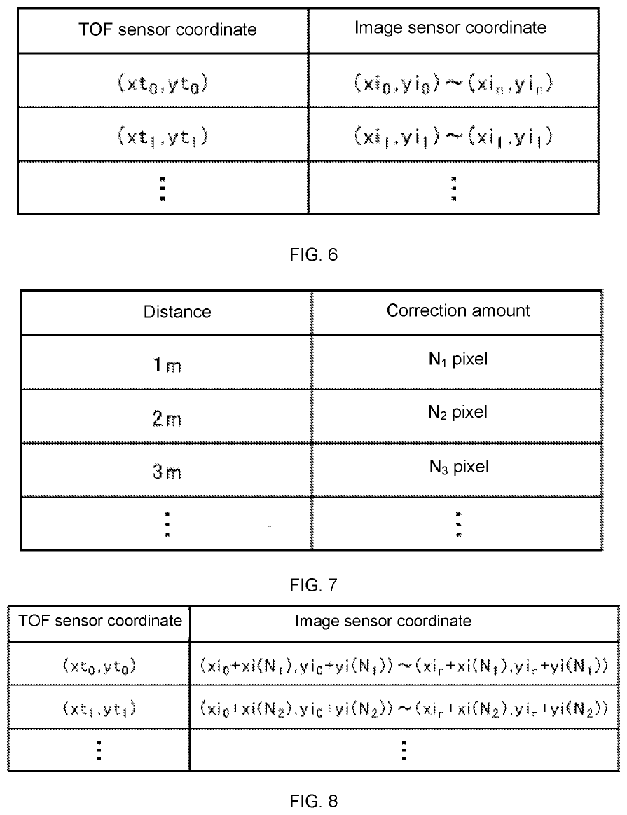

As shown in FIG. 6, the memory 130 may store a table presenting the correspondence between the coordinate system associated with the light-receiving surface of the TOF sensor 160 and the coordinate system associated with the light-receiving surface of the image sensor 120 as a predetermined positional relationship. In other words, the memory 130 may store coordinate values of the plurality of photographing areas of the image sensor 120 corresponding to coordinate values of the distance measurement areas of the TOF sensor 160. As shown in FIG. 7, the memory 130 may store a correction amount corresponding to the distance to the photographed object for each combination of the angle of view of the TOF sensor 160 and the angle of view of the photographing apparatus 100 as a predetermined correction condition.

As shown in FIG. 8, the photographing control portion 110 may refer to the predetermined positional relationship and predetermined correction conditions stored in the memory 130, and for each distance measurement area, move the position of the photographing area by a corresponding correction amount to correct the predetermined positional relationship.

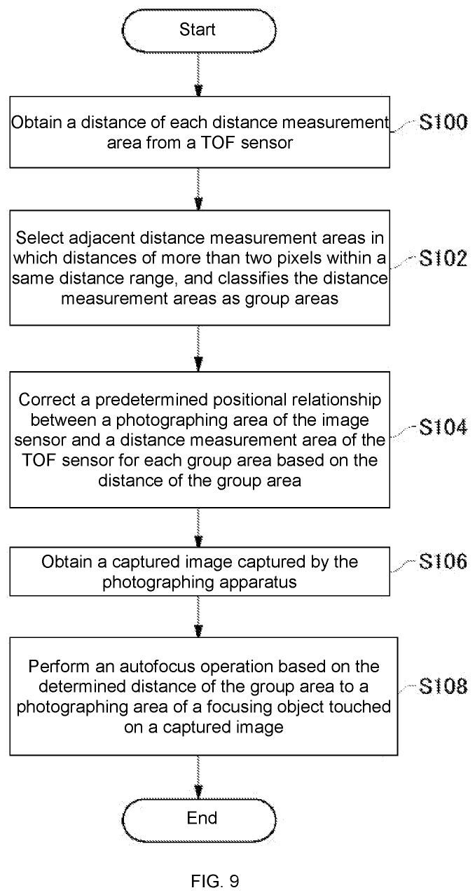

FIG. 9 is a flowchart showing an example of a focus control process of the photographing control portion 110. The photographing control portion 110 obtains a distance of each distance measurement area from the TOF sensor 160 (S100). The photographing control portion 110 selects adjacent distance measurement areas in which distances of more than two pixels within a same distance range, and classifies the distance measurement areas as group areas (S102). The photographing control portion 110 determines a distance of each group area. The photographing control portion 110 determines, for example, a distance of a distance measurement area located in a reference position among a plurality of distance measurement areas included in the group area, as the distance of the group area. The photographing control portion 110 may determine an average distance of distances of a plurality of distance measurement areas included in the group area, as the distance of the group area. The photographing control portion 110 may weight each of a plurality of distance measurement areas included in the group area, and determine a weighted average distance of the distances as the distance of the group area.

The photographing control portion 110 corrects a predetermined positional relationship between a photographing area of the image sensor 120 and a distance measurement area of the TOF sensor 160 for each group area based on the distance of the group area. The photographing control portion 110 may correct the predetermined positional relationship based on a predetermined correction condition indicating a correction amount of each distance corresponding to a combination of an angle of view of the TOF sensor 160 and an angle of view of the photographing apparatus 100.

The photographing control portion 110 obtains a captured image captured by the photographing apparatus 100 (S106). The photographing apparatus 100 may display a preview image obtained by superimposing a box indicating an existing position of a photographed object, on a position of the captured image and corresponding to the group area on the display portion 302 or the like. The photographing control portion 110 determines a distance of a group area corresponding to a photographing area of a focused object touched by a user on the captured image displayed by the display portion 302. The user may touch a box including the desired photographed object in at least one box displayed in the preview image. The photographing control portion 110 performs an autofocus operation, that is, focus control, based on the determined distance of the group area (S108).

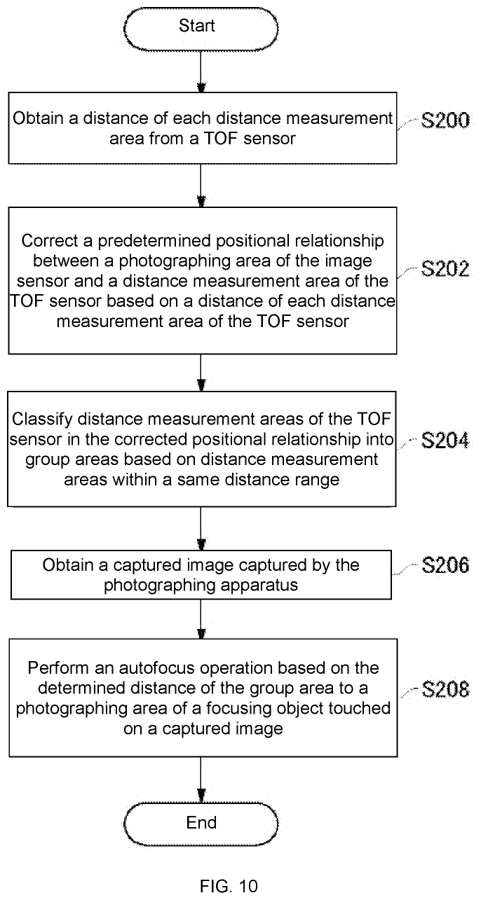

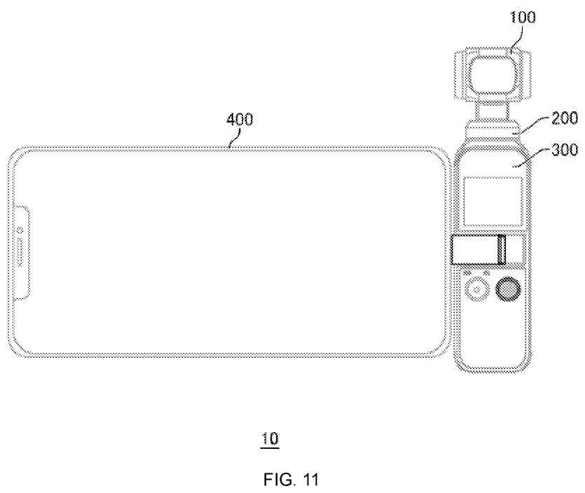

FIG. 10 is a flowchart showing an example of a focus control process of the photographing control portion 110.

The photographing control portion 110 obtains a distance of each distance measurement area from the TOF sensor 160 (S200). The photographing control portion 110 corrects a predetermined positional relationship between a photographing area of the image sensor 120 and a distance measurement area of the TOF sensor 160 based on a distance of each distance measurement area of the TOF sensor 160 (S202). The photographing control portion 110 may correct the predetermined positional relationship based on a predetermined correction condition indicating a correction amount of each distance corresponding to a combination of an angle of view of the TOF sensor 160 and an angle of view of the photographing apparatus 100 and the distance of each distance measurement area of the TOF sensor 160.

The photographing control portion 110 classifies distance measurement areas of the TOF sensor 160 in the corrected positional relationship into group areas based on distance measurement areas within a same distance range (S204). The photographing control portion 110 obtains a captured image captured by the photographing apparatus 100 (S206). The photographing apparatus 100 may display a preview image obtained by superimposing a box indicating an existing position of a photographed object, on a position of the captured image and corresponding to the group area on the display portion 302 or the like. The photographing control portion 110 determines a distance of a group area corresponding to a photographing area of a focused object touched by a user on the captured image displayed by the display portion 302. The photographing control portion 110 performs an autofocus operation based on the distance of the group area (S208).

According to some exemplary embodiments, considering that a positional relationship between the light-receiving surface of the TOF sensor 160 and the light-receiving surface of the image sensor 120 of the photographing apparatus 100 may vary with a distance to the photographed object measured by the TOF sensor 160, a positional relationship between a position of the photographed object on the light-receiving surface of the TOF sensor 160 and a position of the photographed object on the light-receiving surface of the image sensor 120 of the photographing apparatus 100 is corrected. Therefore, the photographing apparatus 100 can perform focus control based on the distance of the photographed object detected based on distance measurement information of the TOF sensor 160, to focus on the desired photographed object.

For example, when the photographing apparatus 100 photographs a person wearing white clothes and standing in front of a white wall, sometimes the photographing apparatus 100 cannot identify the person from a captured image. Even in this case, the TOF sensor 160 can measure a distance of the person. The photographing apparatus 100 classifies a plurality of distance measurement areas of the TOF sensor 160 into group areas based on distances measured by the TOF sensor 160 and adjacent distance measurement areas within a same distance range. In addition, the photographing apparatus 100 may correct the positional relationship between the position on the light-receiving surface of the TOF sensor 160 and the position on the light-receiving surface of the image sensor 120 based on a distance of a group area. The photographing apparatus 100 displays a captured image obtained by superimposing a box indicating an existing position of the person, on a position of the captured image corresponding to the group area, as a preview image on the display portion 302 or the like. The user touches the box. The photographing apparatus 100 determines, based on the corrected positional relationship, the group area corresponding to the position of the touched box. The photographing apparatus 100 performs focus control based on the distance of the group area measured by the TOF sensor 160. Therefore, even if the photographed object cannot be identified from the captured image, the photographing apparatus 100 can reliably focus on the desired photographed object existing at an arbitrary distance.

An example in which the optical axis of the image sensor 120 and the optical axis of the TOF sensor 160 are parallel has been described herein. However, the optical axis of the image sensor 120 and the optical axis of the TOF sensor 160 may not be parallel. The angle of view of the photographing apparatus 100 may be less than the angle of view of the TOF sensor 160.

FIG. 11 is an example of an exterior perspective view of the photographing system 10. As shown in FIG. 11, the photographing system 10 may be used in a state in which a mobile terminal including a display such as a smartphone 400 is fixed to one side of the holding portion 300.

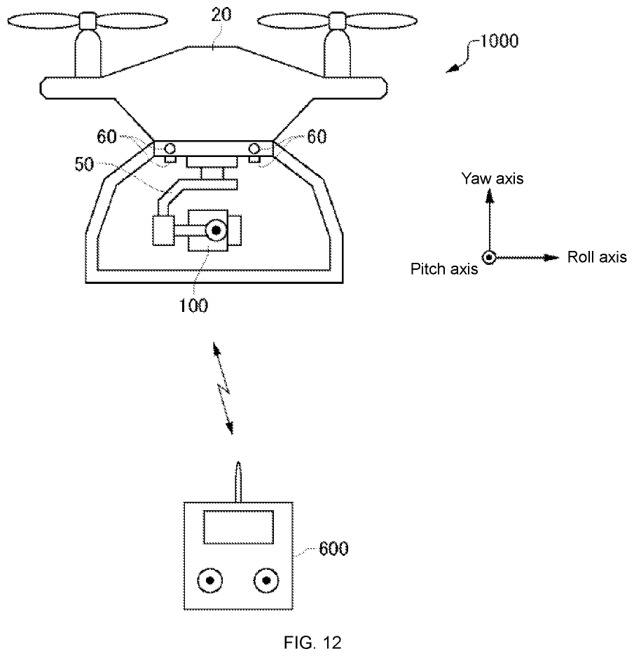

The photographing apparatus 100 may be mounted on a mobile body. The photographing apparatus 100 may be mounted on an unmanned aerial vehicle (UAV) shown in FIG. 12. The UAV 1000 may include a UAV body 20, a universal joint 50, a plurality of photographing apparatuses 60, and a photographing apparatus 100. The universal joint 50 and the photographing apparatus 100 are an example of a photographing system. The UAV 1000 is an example of a mobile body propelled by a propulsion portion. In addition to the UAV, the mobile body may further include a flying body moving in the air, a vehicle moving on the ground, and a ship moving on water.

The UAV body 20 may include a plurality of rotors. The plurality of rotors is an example of a propulsion portion. The UAV body 20 enables the UAV 1000 to fly by controlling rotation of the plurality of rotors. The UAV body 20 uses, for example, four rotors to enable the UAV 1000 to fly. The quantity of rotors is not limited to four. In addition, the UAV 1000 may also be a fixed-wing aircraft without rotors.

The photographing apparatus 100 may be a photographing camera that photographs a photographed object included in a desired photographing range. The universal joint 50 may rotatably support the photographing apparatus 100. The universal joint 50 is an example of a supporting mechanism. For example, the universal joint 50 may use an actuator to rotatably support the photographing apparatus 100 around a pitch axis. The universal joint 50 may also use an actuator to further rotatably support the photographing apparatus 100 around a roll axis and a yaw axis respectively. The universal joint 50 may change a posture of the photographing apparatus 100 by rotating the photographing apparatus 100 around at least one of the yaw axis, the pitch axis, or the roll axis.

The plurality of photographing apparatuses 60 may be sensing cameras that photograph surroundings of the UAV 1000 to control flight of the UAV 1000. Two photographing apparatuses 60 may be disposed on a head of the UAV 1000, that is, on a front side. In addition, other two photographing apparatuses 60 may be disposed on a bottom side of the UAV 1000. The two photographing apparatuses 60 on the front side may be paired to function as a stereo camera. The two photographing apparatuses 60 on the bottom side may also be paired to function as a stereo camera. Three-dimensional spatial data around the UAV 1000 may be generated based on images captured by the plurality of photographing apparatuses 60. A quantity of photographing apparatuses 60 included in the UAV 1000 is not limited to four. The UAV 1000 may include at least one photographing apparatus 60. Alternatively, the UAV 1000 may include at least one photographing apparatus 60 on each of the head, tail, lateral sides, bottom side, and top side of the UAV 1000. An angle of view that can be set with the photographing apparatus 60 may be greater than an angle of view that can be set with the photographing apparatus 100. The photographing apparatus 60 may also have a single-focus lens or a fisheye lens.

A remote operation apparatus 600 may communicate with the UAV 1000 to perform a remote operation on the UAV 1000. The remote operation apparatus 600 may perform wireless communication with the UAV 1000. The remote operation apparatus 600 sends, to the UAV 1000, instruction information of various instructions about moving of the UAV 1000, for example, ascending, descending, accelerating, decelerating, moving forward, moving backward, or rotating. The instruction information may include, for example, instruction information enabling the UAV 1000 to ascend. The instruction information may indicate a height at which the UAV 1000 should be located. The UAV 1000 moves, to reach the height indicated by the instruction information sent from the remote operation apparatus 600. The instruction information may include an ascending instruction enabling the UAV 1000 to ascend. The UAV 1000 ascends during receiving of the ascending instruction. When the height of the UAV 1000 has reached an upper height limit, even if the ascending instruction is received, the ascending of the UAV 1000 may be limited.

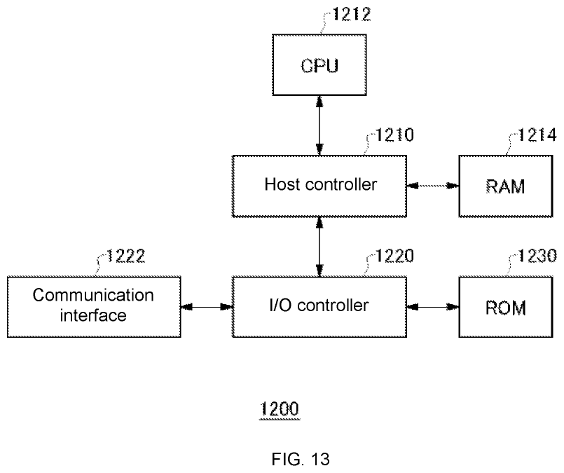

FIG. 13 shows an example of a computer 1200 that may reflect a plurality of aspects of the present disclosure. A program installed in the computer 1200 may enable the computer 1200 to function as an operation associated with an apparatus in the implementation of the present disclosure or one or more “portions” of the apparatus. Alternatively, the program may enable the computer 1200 to perform the operation or the one or more “portions”. The program may enable the computer 1200 to perform the process in the implementation of the present disclosure or a stage of the process. The program may be executed by a CPU 1212, to enable the computer 1200 to perform specified operations associated with some or all blocks in the flowchart and block diagram in the present disclosure.

The computer 1200 in some exemplary embodiments may include the CPU 1212 and a RAM 1214, which are interconnected by a host controller 1210. The computer 1200 may further include a communication interface 1222 and an input/output unit, which are connected to the host controller 1210 by an input/output controller 1220. The computer 1200 may further include a ROM 1230. The CPU 1212 works according to programs stored in the ROM 1230 and the RAM 1214, thereby controlling various units.

The communication interface 1222 may communicate with other electronic apparatuses through a network. A hard disk drive may store programs and data that are used by the CPU 1212 in the computer 1200. The ROM 1230 stores a boot program and so on executed by the computer 1200 during operations, and/or programs of hardware depending on the computer 1200. The programs may be provided by a computer-readable recording medium such as a CD-ROM, a USB memory, or an IC card, or provided by the network. The programs may be installed in the RAM 1214 or the ROM 1230 which are also used as an example of the computer-readable recording medium, and may be executed by the CPU 1212. Information recorded in the programs is read by the computer 1200, and causes cooperation between the programs and the foregoing various types of hardware resources. An information operation or processing may be implemented based on use of the computer 1200 to constitute an apparatus or a method.

For example, when the computer 1200 communicates with an external apparatus, the CPU 1212 may execute a communication program loaded in the RAM 1214, and command, based on processing described in the communication program, the communication interface 1222 to perform communication processing. Under the control of the CPU 1212, the communication interface 1222 reads sending data from a sending buffer provided in a recording medium such as the RAM 1214 or a USB memory, and sends the read sending data to the network, or writes received data received from the network into a receiving buffer provided in the recording medium, or the like.

In addition, the CPU 1212 may enable the RAM 1214 to read all or a required part of files or databases stored in an external recording medium such as a USB memory, and perform various types of processing on data in the RAM 1214. Then the CPU 1212 may write processed data back to the external recording medium.

Various types of information such as various types of programs, data, tables, and databases may be stored in the recording medium for information processing. For data read from the RAM 1214, the CPU 1212 may perform various types of processing such as various types of operations specified by an instruction sequence of the program, information processing, condition judgment, conditional transfer, unconditional transfer, and information retrieval/replacement, which are described throughout the present disclosure, and write results back to the RAM 1214. In addition, the CPU 1212 may retrieve information in a file or database or the like in the recording medium. For example, when the recording medium stores a plurality of items having attribute values of first attributes respectively associated with attribute values of second attributes, the CPU 1212 may retrieve, from the plurality of items, an item matching a condition of an attribute value of a specified first attribute, and read an attribute value of a second attribute stored in the item, to obtain the attribute value of the second attribute associated with the first attribute satisfying the predetermined condition.

The foregoing program or software module may be stored in the computer 1200 or in a computer-readable storage medium near the computer 1200. In addition, a recording medium such as a hard disk or a RAM provided in a server system connected to a private communications network or the Internet may be used as a computer-readable storage medium, so that the program can be provided to the computer 1200 through the network.

The control apparatus according to the present disclosure may be the computer described above. Specifically, the control apparatus may include at least one storage medium storing a set of instructions for controlling the photographing apparatus; and at least one processor in communication with the at least one storage medium; during operation, the at least one processor may execute the set of instructions to perform the implementations described in this disclosure, including the processes of focus control the photographing control portion as illustrated in FIGS. 9 and 10. Although the present disclosure is described with the implementations above, the technical scope of the present disclosure is not limited to the scope described in the implementations. For a person of ordinary skill in the art, apparently variations or improvements may be made to the implementations. Obviously, as set forth in the claims, these variations or improvements should be included in the technical scope of the present disclosure.

It should be noted that an execution sequence of various processes such as actions, sequences, steps, and stages in the apparatus, system, program, and method in the claims, specification, and drawings of the disclosure may be any sequence that can be implemented as long as an output of a previous process is not used in a subsequent process and wordings such as “before” and “beforehand” are not particularly indicated explicitly. For operation procedures in the claims, specification, and drawings of the disclosure, “first”, “then”, and the like are used for ease of description, but do not mean that the implementation needs to be performed in such a sequence.

What is claimed is:

1. A control apparatus for controlling a photographing apparatus, comprising:
at least one storage medium storing a set of instructions for controlling the photographing apparatus, wherein the photographing apparatus includes:
a TOF(Time of Flight) sensor that measures distances of a plurality of objects, each of the plurality of objects being corresponding to a distance measurement area on a light receiving surface of a light receiving element, and
an image sensor that captures an image of the plurality of photographed objects; and
at least one processor in communication with the at least one storage medium, wherein during operation, the at least one processor executes the set of instructions to:
determine, based on a plurality of distances measured by the TOF sensor, a plurality of adjacent distance measurement areas within a predetermined distance range as a group area, and
display a box including the group area on a display portion as the box indicating an existing position of the photographed object.

2. The control apparatus according to claim 1, wherein the at least one processor further executes the set of instructions to perform an autofocus operation based on the box.

3. The control apparatus according to claim 1, wherein the at least one processor further executes the set of instructions to:
correct, based on a plurality of distances measured by the TOF sensor, a predetermined positional relationship between the plurality of distance measurement areas on the light-receiving surface of the light-receiving element and a plurality of photographing areas on a light-receiving surface of the image sensor, to obtain a corrected positional relationship;
determine, based on the corrected positional relationship, a first distance measurement area corresponding to a first photographing area of a focused object; and
perform, based on a distance of the first distance measurement area measured by the TOF sensor, focus control of the photographing apparatus.

4. The control apparatus according to claim 3, wherein the at least one processor further executes the set of instructions to:
classify the plurality of distance measurement areas into group areas based on the plurality of distances measured by the TOF sensor and adjacent distance measurement areas within a predetermined distance range;
correct the positional relationship for each of the group areas;
determine, based on the corrected positional relationship, a group area corresponding to the first photographing area; and
perform focus control of the photographing apparatus based on a distance of the group area that is obtained based on the plurality of distances measured by the TOF sensor.

5. The control apparatus according to claim 4, wherein the at least one processor further executes the set of instructions to:
perform the focus control of the photographing apparatus based on a distance of a distance measurement area located in a reference position among distance measurement areas in the group area.

6. The control apparatus according to claim 1, wherein the at least one processor further executes the set of instructions to:
superimpose the box indicating a position of the photographed object, on a position corresponding to the group area in the image captured by the photographing apparatus; and
display the box on the display portion.

7. The control apparatus according to claim 3, wherein the at least one processor further executes the set of instructions to:
classify, based on the corrected positional relationship, the plurality of distance measurement areas into group areas based on adjacent distance measurement areas within a predetermined distance range;
determine, based on the corrected positional relationship, a group area corresponding to the first photographing area; and
perform focus control of the photographing apparatus based on a distance of the group area that is obtained based on the plurality of distances measured by the TOF sensor.

8. The control apparatus according to claim 7, wherein the at least one processor further executes the set of instructions to:
perform the focus control of the photographing apparatus based on a distance of a distance measurement area located in a reference position among distance measurement areas in the group area.

9. The control apparatus according to claim 7, wherein the at least one processor further executes the set of instructions to:
superimpose the box indicating a position of the photographed object, on a position corresponding to the group area in the image captured by the photographing apparatus; and
display the box on the display portion.

10. The control apparatus according to claim 3, wherein
the predetermined positional relationship is determined based on a positional relationship between a position of an optical axis center on the light-receiving surface of the light-receiving element and a position of an optical axis center on the light-receiving surface of the image sensor.

11. The control apparatus according to claim 3, wherein
the predetermined positional relationship represents a correspondence between a first coordinate system associated with the light-receiving surface of the light-receiving element and a second coordinate system associated with the light-receiving surface of the image sensor.

12. The control apparatus according to claim 3, wherein the at least one processor further executes the set of instructions to:
determine correction amounts corresponding to the plurality of distances measured by the TOF sensor, based on a predetermined correction condition indicating a correction amount of a positional relationship corresponding to an angle of view of the TOF sensor, an angle of view of the photographing apparatus, and the distance to the photographed object; and
correct the positional relationship based on the correction amounts determined.

13. A photographing apparatus, comprising:
a TOF(Time of Flight) sensor that measures distances of a plurality of objects, each of the plurality of objects being corresponding to a distance measurement area on a light receiving surface of a light receiving element;
an image sensor that captures an image of the plurality of photographed objects; and
a control apparatus, including:
at least one storage medium storing a set of instructions for controlling the photographing apparatus, and
at least one processor in communication with the at least one storage medium, wherein during operation, the at least one processor executes the set of instructions to:
determine, based on a plurality of distances measured by the TOF sensor, a plurality of adjacent distance measurement areas within a predetermined distance range as a group area, and
display a box including the group area on a display portion as the box indicating an existing position of the photographed object.

14. The photographing apparatus according to claim 13, wherein the at least one processor further executes the set of instructions to perform an autofocus operation based on the box.

15. The photographing apparatus according to claim 13, wherein the at least one processor further executes the set of instructions to:
correct, based on a plurality of distances measured by the TOF sensor, a predetermined positional relationship between the plurality of distance measurement areas on the light-receiving surface of the light-receiving element and a plurality of photographing areas on a light-receiving surface of the image sensor, to obtain a corrected positional relationship;
determine, based on the corrected positional relationship, a first distance measurement area corresponding to a first photographing area of a focused object; and
perform, based on a distance of the first distance measurement area measured by the TOF sensor, focus control of the photographing apparatus.

16. The photographing apparatus according to claim 13, wherein the at least one processor further executes the set of instructions to:
superimpose the box indicating a position of the photographed object, on a position corresponding to the group area in the image captured by the photographing apparatus; and
display the box on the display portion.

17. The photographing apparatus according to claim 15, wherein the at least one processor further executes the set of instructions to:
classify, based on the corrected positional relationship, the plurality of distance measurement areas into group areas based on adjacent distance measurement areas within a predetermined distance range;
determine, based on the corrected positional relationship, a group area corresponding to the first photographing area; and
perform focus control of the photographing apparatus based on a distance of the group area that is obtained based on the plurality of distances measured by the TOF sensor.

18. The photographing apparatus according to claim 15, wherein the at least one processor further executes the set of instructions to:
the predetermined positional relationship is determined based on a positional relationship between a position of an optical axis center on the light-receiving surface of the light-receiving element and a position of an optical axis center on the light-receiving surface of the image sensor.

19. A control method for controlling a photographing apparatus, comprising:
providing a photographing apparatus including:
a TOF(Time of Flight) sensor that measures distances of a plurality of objects, each of the plurality of objects being corresponding to a distance measurement area on a light receiving surface of a light receiving element,
an image sensor that captures an image of the plurality of photographed objects, and
a control apparatus;
determining, based on a plurality of distances measured by the TOF sensor, a plurality of adjacent distance measurement areas within a predetermined distance range as a group area; and
displaying a box including the group area on a display portion as the box indicating an existing position of the photographed object.

20. The control method according to claim 19, wherein the control apparatus further performing an autofocus operation based on the box.
